(19) United States
(12) Patent Application Publication
(10) Pub. No.: US 2023/0008926 A1
(43) Pub. Date: Jan. 12, 2023

(54) Sensor

(71) Applicant: InnovationLab GmbH, Heidelberg (DE)

(72) Inventor: Christoph Kaiser, Kirkel Limbach (DE)

(21) Appl. No.: 17/784,784

(22) PCT Filed: Dec. 10, 2020
(86) PCT No.: PCT/EP2020/085490

§ 371 Date: Jun. 13, 2022

(30) Foreign Application Priority Data
Dec. 13, 2019 (LU) LU101548

(51) Int. Cl. G01L 1/22

(52) U.S. Cl. CPC G01L 1/2293

(57) ABSTRACT

A sensor for pressure detection which comprises a first substrate (C1) and a second substrate (C2), which are arranged in a planar manner at a distance from each other; a first electrode 5 (A1) arranged on an inner side of the first substrate (C1) and a second electrode (A2) arranged on an inner side of the second substrate (C2); a first force sensitive element (B1) arranged on the inner side of the first substrate and covering at least a part of the first electrode (A1) and a second force sensitive element (B2) arranged on the inner side of the first substrate and covering at least part of the second electrode (A2); and one or more stiffening elements (D1, D2, D3, D4) arranged on at least one of the first substrate (C1) or the second substrate (C2), characterized in that, one or more stiffening elements (D1, D2, D3, D4) define stiffer substrate regions (SR), arranged adjacent to the first force-sensitive element (B1) and the second force-sensitive element (B2).

### CROSS-REFERENCE TO RELATED APPLICATIONS

The present application is a US National Stage of International Application No. PCT/EP2020/085490 filed on Dec. 10, 2020, which claims priority to Luxembourg Patent Application No. LU101548 filed on Dec. 13, 2019.

### BACKGROUND OF THE INVENTION

### Field of the Invention

The field of the invention concerns sensor technology and more particularly to a sensor for measuring deflections of surfaces.

Brief Description of the Related Art

A deflection beam sensor converting a deflection of a surface into a pressure value in order to measure the pressure and thus determining the deflection of the surface is known from the European Patent application EP 1176408 A2. This document discloses a device which has at least one bearer body element to which a force is applied, and which carries resistive elements. Thick film and thin film resistors or strain gauges are used as resistive elements.

A pressing or pushing force sensor is also known from the international patent application WO 2014/017407 A1. The pushing force sensor of this document is provided with sensor elements configured with a piezoelectric film or a resistor film, a wiring conductor for connecting a pushing force-detecting electrode and a flexible printed circuit board. The sensor elements are bent by a pushing force which causes an electrical signal corresponding to the value of the pushing force to be produced from the pushing force-detecting electrodes. In order to detect the pushing force, the sensor needs a stiff counterpart when the pushing force is applied to the sensor.

The international patent application WO 2008/030594 A2 teaches a touch screen assembly for an electronic device. The touch screen assembly comprises a plurality of force sensitive resistor sensors (FSR sensors) arranged in a shunt-mode configuration which are positioned behind a display and thus form a touch screen. The approximate position of a pressure point on the touch screen can be determined based on the measurement data of the sensors.

US Patent Application No. US 2012/222499 A1 teaches a pressure detection unit which includes a first substrate and a second substrate disposed opposite to each other and are subject to a load from the outside. The first and second substrate comprise electrodes disposed linearly opposite to each other. Electrically conductive pressure-sensitive ink is disposed between the electrodes to cover at least one of these electrodes. The pressure-sensitive ink has electrical characteristics which varies according to the load. An adhesion member is used for adhering the first substrate and the second substrate to each other with the electrodes and the pressure-sensitive ink being placed in contact with each other.

International Patent Application WO 2011/138200 A1 teaches an input device for human-appliance interaction comprises a pressure sensor in form of a membrane switch including a first carrier film, a second carrier film and a spacer with at least one gap defining a sensor cell. The input device further comprises a base member, on which the pressure sensor is applied with its second carrier film, and a cover member exposed for user interaction and arranged on the first carrier film to transmit a force applied thereon to the first carrier film. The cover member is spaced from the first carrier film by at least one force-transmitting element centered on the sensor cell in such a way that the force applied on the cover member is transmitted to the first carrier film via the force-transmitting element and causes the first carrier film to bend into the sensor cell.

A further known solution to detect a pressure input is the use of buttons as pressure counterparts which are embedded into the metal surface in order to generate a signal representative of the pressure by pushing against the metal surface.

The prior art is silent about a pressure measuring sensor which uses a conductive material surface to detect a pressure input on the conductive material surface and which results are not affected by capacitance change because of the conductivity of the conductive material surface, e.g. metal surface. The prior art is also silent about a low measurability of the pressure input because of the stiffness of the metal carrier surface.

The prior art does not teach measuring a deflection of a surface based on the idea of using a compressive stress caused by an applied external force on the surface of the pressure measuring sensor.

### SUMMARY OF THE INVENTION

The present document describes a sensor which detects a pressure input caused by an external force applied to a surface and allows the sensor to respond to the pressure input which is converted into a deflection of the surface by measuring the compressive stress caused by the pressure input directly on the metal surface. The detection could be additionally be limited to a defined area of the pressure input on the surface.

The sensor comprises a first substrate and a second substrate arranged in a planar manner at a distance from each other. A first electrode is arranged on an inner side of the first substrate and a second electrode is arranged on an inner side of the second substrate. A first force sensitive element is arranged on the inner side of the first substrate and covers at least a part of the first electrode. A second force sensitive element is arranged on the inner side of the first substrate and covers at least part of the second electrode. Additionally, there are one or more stiffening elements arranged on at least one of the first substrate or the second substrate. This enables the measurement of the signal without having a counterpart which opens a new range of applications for the sensor. Without the need of a counterpart, the sensor can be constructed smaller in size and placed for example behind surfaces which are exposed to pressure. In this way, points or surfaces of interest can be retrofitted with the sensor and sensed without having to construct a counterpart for the sensor.

In a first aspect, the first force sensitive element and the second force sensitive element of the sensor are made of a force sensitive resistor (FSR) material. The FSR material enables measurement of a change of voltage when a force is applied onto the FSR material.

In another aspect, the force sensitive elements are arranged in a thru-mode or shunt-mode configuration.

In another aspect, the one or more stiffening elements are arranged on the outer side of the first substrate or the second substrate. The stiffening elements allow the metal deflection to be used to achieve a larger deformation of the sensor, which will be explained in more detail below.

In another aspect, the one or more stiffening elements are made from UV-curing varnishes. The UV-curing varnishes are very stable and can be easily printed on the surface of the first substrate or the second substrate. The stiffening elements are more torsion-resistant than either of the first substrate or the second substrate.

In another aspect, at least one of the first substrate and the second substrate have stiffer substrate regions. The stiffer substrate regions are harder to bend than electrode regions in which the electrodes are located. The stiffer substrate regions act as concentrator and converter that converts the deflection to a force and concentrates the force to the force sensitive area. In other words, a small deflection of the metal plate or shaped form and thus of the first substrate and/or the second substrate caused by the applied external force is transferred by the stiffer substrate regions to cause a larger deflection of the electrode regions and thus a larger pressure in the electrode regions of the sensor at which the strength of the external force can be measured. The stiffer substrate regions serve therefore as a concentrator or an amplifier of the external force applied to the sensor.

In another aspect, the stiffening elements are adapted to convert a deflection of the sensor into a pressure on the sensor surfaces.

A method for measuring a deflection is also disclosed. This method comprises the steps of applying an external force to a metal plate or shaped form in the sensor. The external force causes a deflection of a portion of the metal plate or shaped form and the external force vector is distributed into force vectors in the metal plate or shaped form which result in a compressive stress in the electrode regions of the sensor. The sensor generates a pressure signal based on the force vectors of the applied external force. The pressure signal generated is representative of the deflection of the metal plate or shaped form.

### BRIEF DESCRIPTION OF THE DRAWINGS

FIG. 1 is an illustration (not to scale) of an embodiment of the sensor with the sensitive elements including electrodes.

FIG. 2 is an illustration (not to scale) of the sensor mounted to a metal plate or shaped form.

FIG. 3 is an illustration (not to scale) of the sensor of FIG. 2 with an applied external force.

FIG. 4 is an illustration (not to scale) of the sensor of FIG. 2 with an applied external.

FIG. 5 illustrates the method of the invention.

### DETAILED DESCRIPTION OF THE INVENTION

The invention will now be described on the basis of the drawings. It will be understood that the embodiments and aspects of the invention described herein are only examples and do not limit the protective scope of the claims in any way. The invention is defined by the claims and their equivalents. It will be understood that features of one aspect or embodiment of the invention can be combined with a feature of a different aspect or aspects and/or embodiments of the invention.

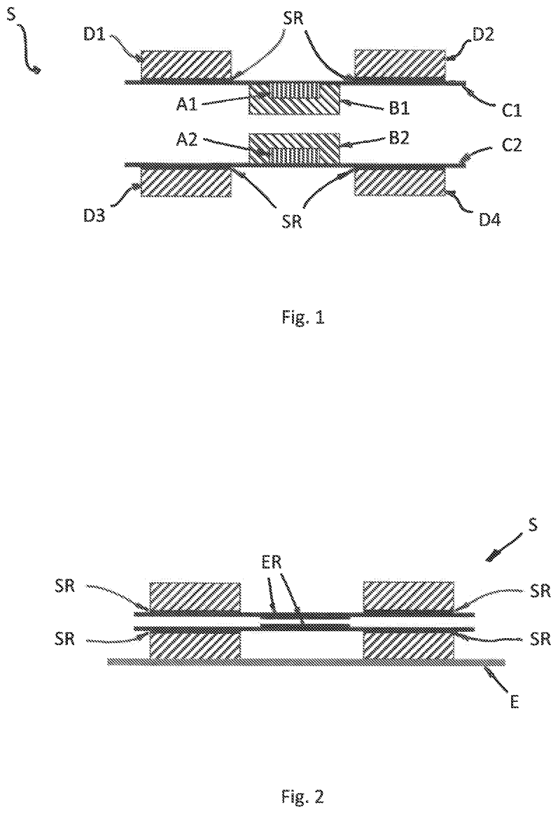

FIG. 1 illustrates an embodiment of a force sensitive sensor S. The sensor S comprises a first substrate C1 and a second substrate C2 arranged in a planar manner at a distance from each other.

A first electrode A1 is arranged on an inner side of the first substrate C1 and a first force sensitive element B1 is arranged on the inner side of the first substrate C1 and covering at least a part of the first electrode A1. A second electrode A2 is arranged on an inner side of the second substrate C2 and a second force sensitive element B2 is arranged on the inner side of the second substrate C2 and covering at least a part of the second electrode A2.

The surface between the inner side of the first substrate C1 and the second substrate C2, the first electrode A1 and the second electrode A2 as well as the force sensitive elements B1, B2 defines electrode regions ER.

The sensor S further comprises one or more stiffening elements D1, D2, D3, D4 which are arranged on at least one of the first substrate C1 or the second substrate C2 and thereby define stiffer substrate regions SR.

In FIG. 1, the stiffening elements D1, D2, D3, D4 are illustrated on an outer surface of the first substrate C1 and the second substrate C2. It will be apparent that it is possible to arrange the one of more stiffening elements D1, D2, D3, D4 also on an inner side of the first substrate C1 or the second substrate C2. The substrates C1, C2 itself could comprise surfaces which are harder to bend than the electrode regions ER in which the electrodes A1, A2 are located.

The one stiffening elements D1, D2, D3, D4 are arranged on the first substrate C1 or the second substrate C2 by for example gluing, laminating or direct printing with a mechanically stable material, such as but not limited to UV-curing varnish.

The first force sensitive element B1 and the second force sensitive element B2 are made of a force sensitive resistor material comprising, for example, carbon particles embedded in a polymer matrix. The force sensitive resistor material is made, for example, of one of silver or carbon black in a host material. It would be possible to use other metal particles or conductive materials, such as some salts or semiconductor materials, which can be made into particles and put into a host material.

The sensor S as shown in FIG. 1 can be arranged in either a thru-mode or a shunt mode configuration. The sensor S in shunt-mode or thru-mode configuration exhibit different force vs. resistance characteristics. The thru-mode configuration is constructed from two layers of substrate, namely the first substrate C1 and the second substrate C2. The substrate can be made, for example from a polymer film made from one of polyethylene (PE), polyethylene terephthalate (PET), and/or polyimide (PI).

The first electrode A1 is placed on the first substrate C1 and the second electrode A2 is placed on the second substrate C2. Force sensitive elements B1, B2 are printed on the surface of each of the two substrates C1, C2 covering the electrodes A1, A2. The force sensitive elements can be made, for example, of silver, or a silver/graphite blend ink. These two printed substrates C1, C2 with the force sensitive elements B1, B2 and the electrodes A1, A2 are then placed so that the force sensitive elements B1, B2 face each other. Adhesive can be used to laminate the two printed substrates C1 and C2 together to form the sensor. The force sensitive elements B1, B2 on each are connected to the electrodes A1, A2 which act as a single output terminal, and a current can be passed through from one of the printed substrates C1 to another one of the printed substrates C2, hence the name thru-mode.

The shunt-mode configuration is constructed similar as the thru-mode configuration also from two layers of substrate. One of the layers is printed with a force-sensitive resistor made from FSR ink and the other layer is printed with conductive ink to form the electrodes. The two substrates are then positioned such that the force-sensitive resistor faces the electrodes and adhered together using a spacer adhesive in the middle. When the two layers are pressed together, the FSR ink on the first one of the layers bridges or ‘shunts’ the conductor on the other layer.

The material used for forming the force-sensitive resistance is, for example made from carbon in a polymer matrix. It will be understood that for both configurations the following applies: the higher the force asserted on the substrates and thus on the layers with the FSR ink the more conductive the FSR ink will become. Thus, a measurement of the conductivity of the ink should give a result which is representative of the value of the force applied to the substrate.

FIG. 2 shows a sensor S in a thru-mode configuration mounted to a metal plate or shaped form E. The electrode regions ER comprise the electrodes A1, A2 and the force sensitive elements B1, B2 which are very thin in thickness, typically without limitation typical about 5-1 μm layer thickness for each component but also from some nanometers up to some hundreds of micrometers.

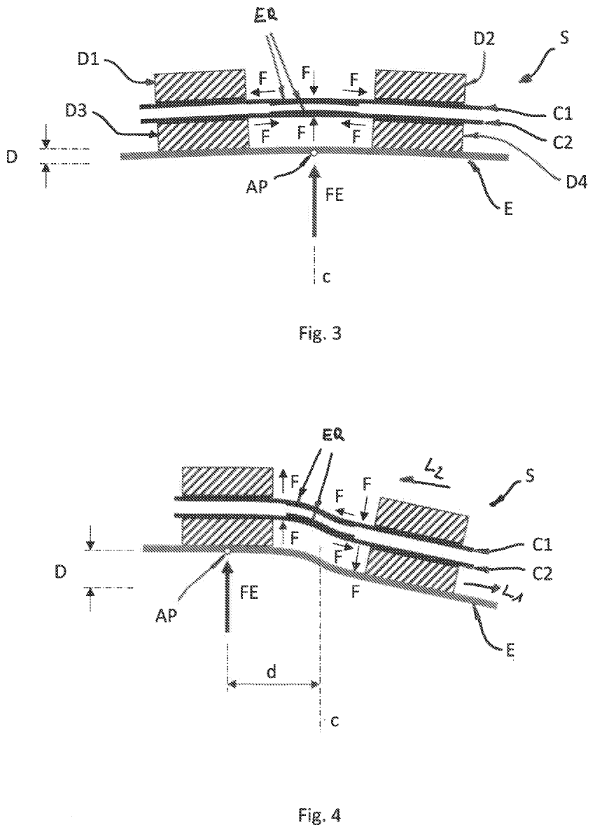

FIG. 3 shows the sensor S from FIG. 2 with an applied external force FE at the metal plate or shaped form E located below or at the center c of the electrode regions ER of the sensor S. The external force FE is distributed into force vectors F which cause a compressive stress, as shown in FIG. 4, with an apex AP of the deflection D of the sensor S just below the electrode regions ER of the sensor S. The second substrate C2 will be compressed because of the compressive stress while the first substrate C1 will be stretched or elongated. In other words, the deflection D caused by the applied external force FE about the electrode regions ER causes the first substrate C1 to be stretched more than the second substrate C2.

The stiffening elements D1, D2, D3, D4 are adapted to avoid a stretching/elongating or compressing of the first substrate C1 or the second substrate C2 in the stiffer substrate regions SR. As the stiffer substrate regions SR are harder to bend, the stiffer substrate regions SR function as an concentrator for the applied external force FE because the force vectors F of the external force FE are absorbed by the electrode regions ER due to the lower stiffness of the electrode regions ER. Thus, the stiffening elements D1, D2, D3, D4 and the resulting stiffer substrate regions SR allow the deflection D of the metal plate or shaped form E to be used to enable a larger deformation of the electrode regions ER of the sensor S. Thus, the deflection D caused by the applied external force FE on the metal plate or shaped form E resulting in a compressive stress on the electrode regions ER of the sensor S mounted directly on the metal plate or shaped form E is measured based on the pressure on the first sensor surface, which is made of the first substrate C1, first electrode A1 and the first force sensitive element B1 and the second sensor surface, which is made of the second substrate C2, second electrode A2 and the second force sensitive element B2.

The force sensitive elements B1, B2 are pressed against each other because of the stretching or elongating of the first sensor surface and the second sensor surface (as shown in FIGS. 3 and 4). The pressing together of the force sensitive elements B1 and B2 causes a change of the resistance between the electrodes A1, A2. The change in resistance can be measured by external measuring devices.

FIG. 4 shows the sensor S of FIG. 2 with an applied external force FE at the metal plate or shaped form E with a distance d to the center c of the electrode regions ER of the sensor S. The external force FE is distributed into force vectors F. If the apex AP of the deflection D is not directly below or at the center c of the electrode regions ER of the sensor S, a relative motion between the first sensor surface and the second sensor surface occurs (see vectors Ll and L2 in FIG. 4). In this case, only shear forces act on the substrates C1, C2, which do not or only to a very small extent result in a change of resistance between the electrodes A1, A2. The sensor S thus can only generate a pressure signal PS if the external force FE is applied at the metal plate or shaped form E right below or centered at the electrode regions ER of the sensor S. The detection is thus limited to a defined area or surface of the metal plate or shaped form E.

A measurable pressure signal PS is generated by the sensor S without the need of a counterpart. The arrangement of the one of more stiffening elements D1, D2, D3, D4 also ensures that the sensor S only generates pressure signals PS when the apex AP of the deformation of the sensor S, i.e. the point where the applied force is applied, is located in the center of the sensor S, i.e. in the electrode regions ER of the sensor S.

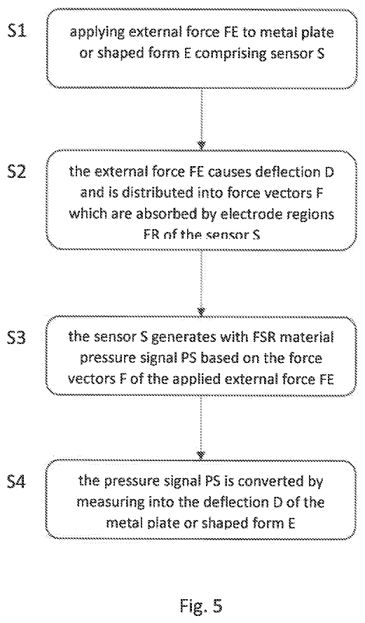

Referring to FIG. 5, a method for measuring a deflection D of a metal plate or shaped form E will be described.

The first step S1 comprises applying an external force FE to the metal plate or shaped form E onto which the sensor S is mounted. In the second step S2, the external force FE causes a small deflection of a portion of the metal plate or shaped form E defining an apex AP of the deflection D. As taught above, the external force FE is distributed into the force vectors F (see FIGS. 3 and 4) and absorbed by the electrode regions ER of the sensor S. The stiffer substrate regions SR concentrates the small deflection D of the portion of the metal plate or shaped form E into a bigger deflection of the electrode regions ER of the sensor S due to the higher stiffness of the stiffer substrate regions SR compared to the electrode regions ER. In the third step S3 the sensor S generates with the FSR material a pressure signal PS based on the force vectors F of the applied external force FE if applied right below or at the center c of the electrode regions ER of the sensor S which is mounted on the metal plate or shaped form E. The deflection D results in the stiffening elements of the sensor acting as a lever and pressing the first and the second sensor surfaces against each other. This mutual pressure causes a change in resistance in the FSR material which can be determined by determining the resistance at the electrodes. In the fourth step S4 the generated pressure signal PS of the sensor S is converted by measuring into the deflection D of the metal plate or shaped form E.

### REFERENCE NUMBERS

S sensor
A1 first electrode
A2 second electrode
B1 first force sensitive element
B2 second force sensitive element
C1 first substrate or foil
C2 second substrate or foil
d distance
D deflection
D1 first stiffening element
D2 second stiffening element
D3 third stiffening element
D4 fourth stiffening element
E metal plate or shaped form
FE external force
F force vector
AP apex of deformation (i.e. the point where the pressure is applied)
ER electrode region
SR stiffer substrate region
PS pressure signal

1. A sensor comprising:
a first substrate (C1) and a second substrate (C2) arranged in a planar manner at a distance from each other;
a first electrode (A1) arranged on an inner side of the first substrate (C1);
a second electrode (A2) arranged on an inner side of the second substrate (C2); a first force sensitive element (B1) arranged on the inner side of the first substrate (C1) and covering at least a part of the first electrode (A1);
a second force sensitive element (B2) arranged on the inner side of the first substrate (C1) and covering at least part of the second electrode (A2); and
one or more stiffening elements (D1, D2, D3, D4) arranged on at least one of the first substrate (C1) or the second substrate (C2), wherein the one or more stiffening elements (D1, D2, D3, D4) define stiffer substrate regions (SR), arranged adjacent to the first force-sensitive element (B1) and the second force-sensitive element (B2).

2. The sensor according to claim 1, wherein the first force sensitive element (B1) and the second force sensitive element (B2) comprise a force sensitive resistor material.

3. The sensor according to claims 1, wherein the force sensitive elements (B1, B2) are arranged in thru-mode or shunt-mode configuration.

4. The sensor according to claim 1, wherein the one or more stiffening elements (D1, D2, D3, D4) are arranged on the outer side of the at least one of the first substrate (C1) or the second substrate (C2).

5. The sensor according to claim 1, wherein the one or more stiffening elements (D1, D2, D3, D4) are made from UV-curing varnishes.

6. The sensor according to claim 1, wherein at least one of the first substrate (C1) and the second substrate (C2) have stiffer substrate regions (SR), wherein the stiffer substrate regions (SR) are harder to bend than electrode regions (ER) in which the electrodes (A1; A2) are located.

7. The sensor according to claim 1, wherein the stiffening elements (D1, D2, D3, D4) are adapted to convert a deflection (D) of the sensor into a pressure on the sensor surfaces.

8. A method for measuring a deflection comprising:
applying an external force (FE) to the metal plate or shaped form (E) comprising a sensor S, the sensor S comprising:
a first substrate (C1) and a second substrate (C2) arranged in a planar manner at a distance from each other;
a first electrode (A1) arranged on an inner side of the first substrate (C1);
a second electrode (A2) arranged on an inner side of the second substrate (C2);
a first force sensitive element (B1) arranged on the inner side of the first substrate (C1) and covering at least a part of the first electrode (A1);
a second force sensitive element (B2) arranged on the inner side of the first substrate (C1) and covering at least part of the second electrode (A2); and
one or more stiffening elements (D1, D2, D3, D4) arranged on at least one of the first substrate (C1) or the second substrate (C2), wherein the
one or more stiffening elements (D1, D2, D3, D4) define stiffer substrate regions (SR), arranged adjacent to the first force-sensitive element (B1) and the second force-sensitive element (B2);
causing a deflection (D) of a portion of the metal plate or shaped form (E) due to the applied external force (FE) which is distributed into force vectors (F) and absorbed by the electrode regions (ER) of the sensor (S);
generating a pressure signal (PS) with the sensor (S) based on the force vectors (F) of the applied external force (FE); and
converting by measuring the pressure signal (PS) into the deflection (D).
